(19) United States
(12) Patent Application Publication
(10) Pub. No.: US 2005/0225668 A1
(43) Pub. Date: Oct. 13, 2005

(54) Mobile communication terminal having selectively exposed camera

(76) Inventor: Jung Woo Kim, Gyeonggi-do (KR)

Correspondence Address: DICKSTEIN SHAPIRO MORIN & OSHINSKY LLP, 2101 L Street, NW, Washington, DC, 20037, US

(21) Appl. No.: 11/088,968

(22) Filed: Mar. 24, 2005

(30) Foreign Application Priority Data
Apr. 13, 2004 (KR) 10-2004-0025351

(51) Int. Cl. H04N 5/225

(52) U.S. Cl. 348/373

(57) ABSTRACT

A mobile communication terminal has a body, a camera installed in a receiving space formed in the body so as to be pivotally moved up and down, a door installed on an outer surface of the body so as to be slidingly moved to open and close an opening of the receiving space, and a cam plate installed in the body as to be slidingly moved in association with the movement of the door to pivotally move the camera. In the mobile communication terminal, when users open the door, the cam plate is linearly moved in association with the movement of the door to pivotally move the camera upward, so that the camera is popped out from the terminal through the opening of the receiving space.

### CROSS-REFERENCE TO RELATED APPLICATIONS

This application claims all benefits of Korean Patent Application No. 2004-25351, filed on Apr. 13, 2004 in the Korean Intelleciual Property Office, the disclosures of which is incorporated herein by reference.

### BACKGROUND OF THE INVENTION

1. Field of the Invention

The present invention relates to a mobile communication terminal having a digital camera, in which the camera is usually received into the terminal and, upon use, is selectively popped out in order to prevent damage of the camera.

2. Description of the Prior Art

Recently, a mobile communication terminal such as cellular phones equipped with digital cameras, Personal Digital Assistant (PDA) and the like has been widely used.

Generally known in the art, a camera was fixedly installed to a certain position of a body or a cover of the terminal. In this case, since a lens of the camera was always exposed outside, the lens could be contaminated with foreign substances, possibly scratched with its surface, and possibly damaged due to external shocks.

Meanwhile, a camera in general includes a lens cover having a structure that a lens is automatically opened only upon shooting in order to protect the same. However, for driving the lens cover, a complex drive mechanism is required because a complex device such as an electric motor should be used, so that it is difficult to directly adapt such complex lens cover structure to the mobile communication terminal that pursues a compact size and a reduced power consumption.

### SUMMARY OF THE INVENTION

Accordingly, the present invention is directed to overcome the above-mentioned disadvantages or limitations occurring in the prior art.

It is an object of the present invention to provide a mobile communication terminal having a camera, in which the camera is normally received in the terminal and closely covered by a door and, upon opening of the door in use, is popped out with an operation in association with opening of the door to prevent damage of the camera due to intrusion of foreign substances or external shocks.

In order to accomplish this object of the present invention, there is provided a mobile communication terminal, comprising a body, a camera installed in a receiving space formed in the body so as to be pivotally moved up and down, a door installed on an outer surface of the body so as to be slidingly moved to open and close an opening of the receiving space, and a cam plate installed in the body as to be slidingly moved in association with the movement of the door to pivotally move the camera.

In the mobile communication terminal, when users open the door, the cam plate is moved in association with the movement of the door to pivotally move the camera upward, so that the camera is popped out from the terminal through the opening of the receiving space.

For the pivotal movement of the camera, the mobile communication terminal of the present invention includes a camera case installed in the receiving space and in which the camera is safely received.

The camera case has a sidewall with a circular guide slot formed thereto, and the camera has a sidewall with a guide protrusion formed thereon so as to be inserted into the guide slot, so that the camera is pivotally moved along a path of the guide slot, selectively being popped out from the body.

Also, in the mobile communication terminal of the present invention, the cam plate includes a slant cam slot having a height corresponding to that of pivotal movement of the camera and a length corresponding to a moving distance of the door, and a connection shaft is further provided for converting a linear movement of the cam plate into a pivotal movement of the camera and which has one end connected with the cam slot as to be slidingly moved along the cam slot and the other end connected with the camera as to be pivotally moved.

For connection of the cam plate with the camera, the mobile communication terminal of the present invention includes a fixing axis protruded from one side of the camera parallel to a movement direction of the cam plate, and a connection loop having one end rotatably fixed to the fixing axis and the other end extending toward the cam plate.

Herein, the connection shaft includes a first shaft portion to be inserted into the cam slot of the cam plate, and a second shaft portion to be inserted into the connection loop.

For the interlocking of the door with the cam plate, the mobile communication terminal of the present invention includes a pair of lift pieces installed spaced apart a certain distance to an upper portion of the cam plate as to be resiliently moved vertically, a spring resiliently supporting the lift piece, a pair of protrusions formed spaced apart a certain distance on a lower surface of the door as to be selectively engaged with a side face of any one of lift pieces along a movement direction of the door so as to interlock the cam plate with the door.

Herein, the lift pieces include slant surfaces, respectively, facing each other, and any one of the lift pieces includes another more-slant surface opposite to the slant surface, the more-slant surface having an angle of inclination larger than that of the slant surface.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a mobile communication terminal according to the present invention;

FIG. 2 is an exploded perspective view of an installing portion for a camera in the mobile communication terminal of FIG. 1;

FIG. 3 is a side view showing an assembled state of the installing portion of FIG. 2;

FIG. 4 is a front view showing an assembled state of the installing portion of FIG. 2;

FIG. 5 is a view showing an installing portion for a camera viewing in a direction A in FIG. 3;

FIG. 6 is a perspective view showing a state that a camera is pivotally moved by roughly half;

FIG. 7 is a side view of FIG. 6;

FIG. 8 is a front view of FIG. 6;

FIG. 9 is a perspective view showing a state that a camera is pivotally moved completely;

FIG. 10 is a side view of FIG. 9;

FIG. 11 is a front view of FIG. 9; and

FIG. 12 is a perspective view of a mobile communication terminal in a state of FIG. 9.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

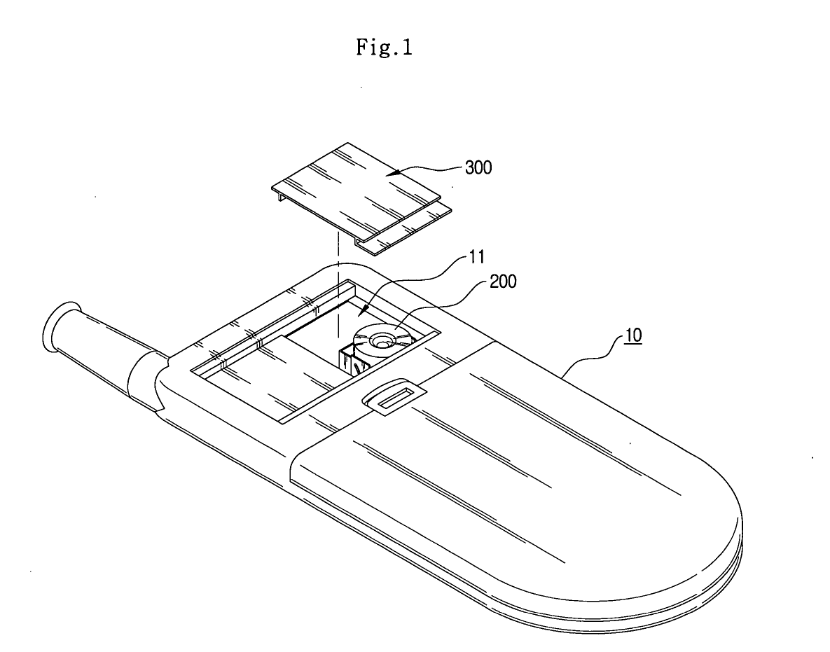

As shown in FIG. 1, a mobile communication terminal of the present invention includes a body 10, a receiving space 11 formed to an upper portion of the body 10 and in which a camera 200 is received, and a sliding door 300 installed on an opening of the receiving space 11 as to be slidingly moved. The door 300 selectively opens or closes the opening of the receiving space 11 while being laterally slid. The camera 200 is pivotally moved in association with the sliding movement of the door 300 so as to be protruded from and received in the receiving space 11.

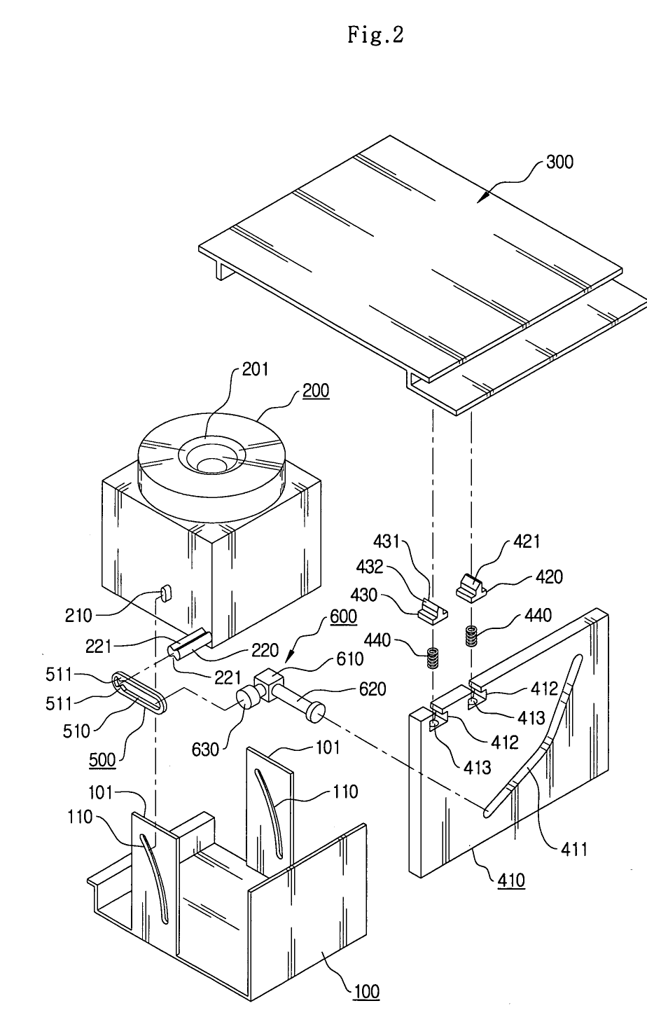

As shown in FIG. 2, in the receiving space 11, a camera case 100 for supporting the camera 200 to be pivotally moved and a cam plate 410 connected with the camera 200 and the door 300, respectively, for interlocking of the camera 200 with the door 300 are provided.

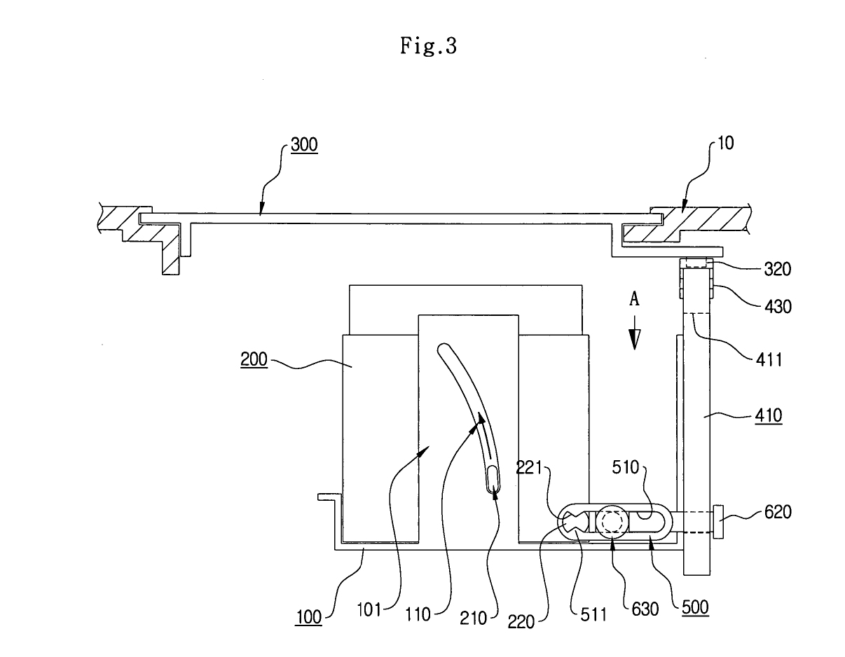

The camera case 100 includes a pair of side plates 101 extending upward along the sidewall of the camera 200. A circular guide slot 110 is formed to the respective side plates 101 so as to guide a pivotal movement of the camera 200. Also, the camera 200 includes guide protrusions 210 at both sidewalls. As shown in FIG. 3, the guide protrusions 210 are moved along a path of the guide slot 110 in a state that the guide protrusions are inserted into the guide slots, so that the camera 200 is guided to be pivotally moved vertically.

Referring again to FIG. 2, the cam plate 410 is laterally slid in the body 10 in association with the movement of the door 300, pivotally moving the camera 200 up ad down. To be concrete, the cam plate 410 is operated such that when the door 300 is moved to a position opening the receiving space 11, the camera 200 being pivotally moved upward along the guide slot 110 to be protruded outside the receiving space 11, and when the door 300 is moved to a position closing the receiving space 11, the camera 200 being pivotally moved downward along the guide slot 110 to be received in the case 100 in the receiving space 11.

To pivotally move the camera 200, a cam slot 411 inclined in a diagonal line is formed on the surface of the cam plate 410. A height and a distance between both ends of the cam slot 411 are determined corresponding to a pivotal movement height of the camera 200 and a linear movement of the door 300.

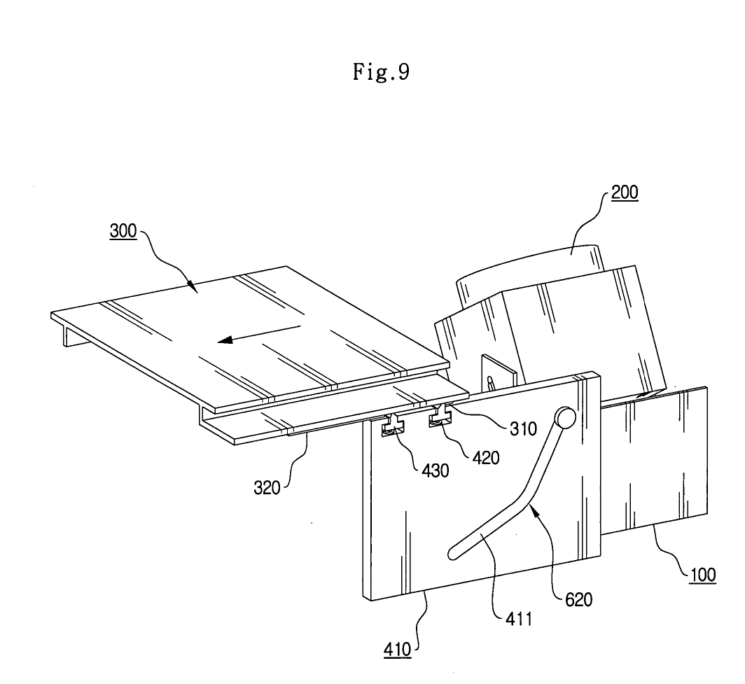

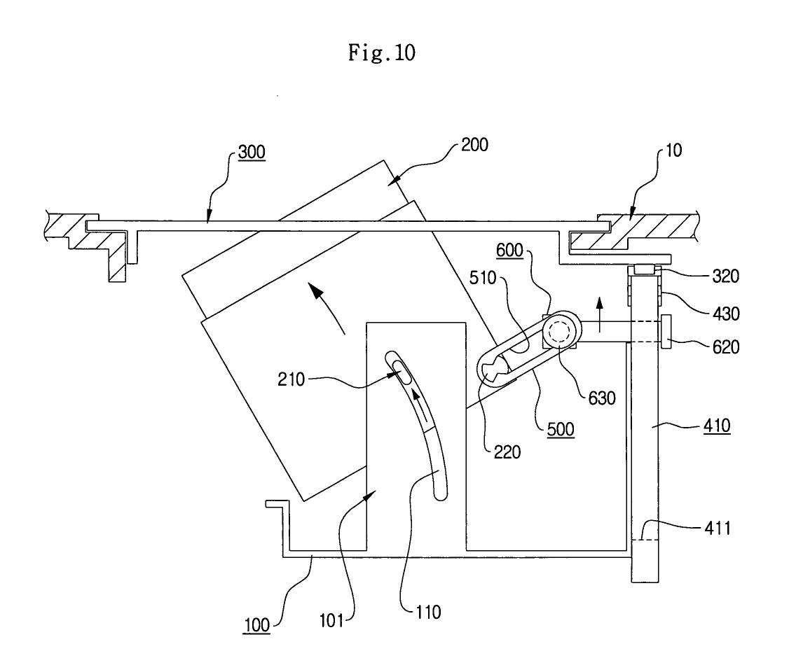

Also, a fixing axis 220 is protruded from one side of the camera 200 parallel to a movement direction of the cam plate 410. A connection loop 500 extending toward the cam plate 410 is coupled to the fixing axis 220. A groove 221 is formed on upper and lower surfaces, respectively, of the fixing axis 220 and a protrusion 511 is formed on an inner surface of a long hole 510 of the connection loop 500, so that when the protrusion 511 of the connection loop 500 is fitted to the groove 221 of the fixing axis 220, the connection loop 500 is coupled with the fixing axis 220. The connection loop 500 has a length corresponding to a distance between the cam plate 410 and the fixing axis 220 when the camera 200 is pivotally moved upward to the end as shown in FIGS. 9 and 10 (i.e., maximum distance).

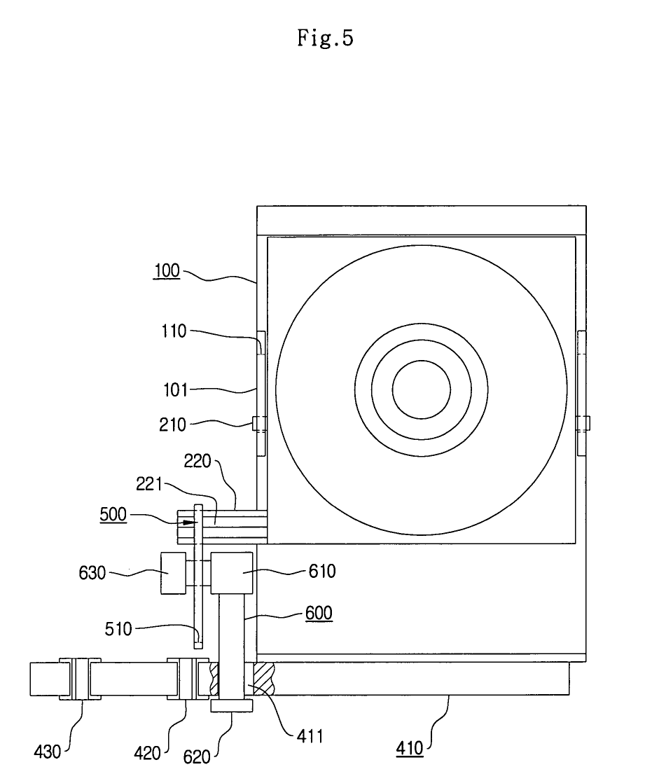

A connection shaft 600 is disposed between the connection loop 500 and the cam plate 410. The connection shaft 600 includes a body 610, a first shaft portion 620 extending from the body 610 toward the cam plate 410, and a second shaft portion 630 extending from the body 610 toward the connection loop 500. As shown in FIG. 5, the first shaft portion 620 is inserted into the cam slot 411 of the cam plate 410 as to be rollingly and slidingly moved therein, and the second shaft portion 630 is inserted into the long hole 510 of the connection loop 500 as to be rollingly and slidingly moved therein.

When the cam plate 410 is laterally moved, the first shaft portion 620 of the connection shaft 600 is moved along the cam slot 411 so that the camera 200 is pivotally moved up and down. When the camera 200 is pivotally moved like this, the fixing axis 220 of the camera 200 is moved away from or toward the cam plate 410. Herein, the second shaft portion 630 of the connection shaft 600 is linearly moved along the long hole 510 of the connection loop 500 while being rolled in the long hole, allowing distance difference between the camera 200 and the cam plate 410.

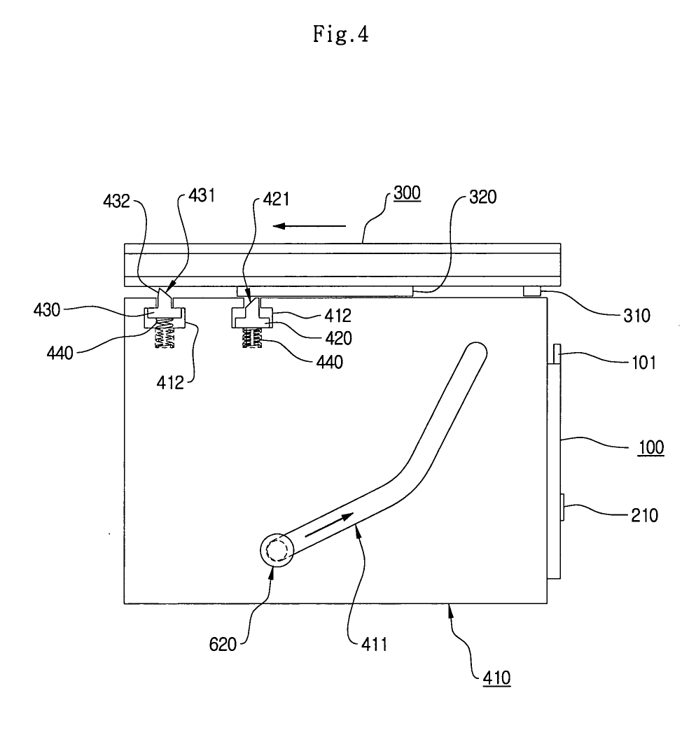

Meanwhile, as shown in FIG. 4, in order to provide an interlinking movement between the door 300 and the cam plate 410, first and second lift pieces 420 and 430 are installed to an upper portion of the cam plate 410 as to be resiliently and vertically moved, and first and second protrusions 310 and 320 are provided on a lower surface of the door 300 so as to press side surfaces of the first and second lift pieces 420 and 430 to move the cam plate 410.

The first and second lift pieces 420 and 430 are provided so that the lower parts thereof are placed in recesses 412 formed to the upper portion of the cam plate 410. A hole 413 is formed in a bottom of the recess 412 and in which a spring 440 is inserted so as to resiliently support the first and second lift pieces 420 and 430.

The first and second lift pieces 420 and 430 include, at their upper portions, slant surfaces 421 and 431, respectively, facing each other. When the first and second protrusions 310 and 320 become to be in contact with the slant surfaces 421 and 431 of the first and second lift pieces 420 and 430, respectively while the door 300 is moved, the first and second lift pieces 420 and 430 are moved downward while pressing the springs 440 thus to be safely received in the recesses 412 of the cam plate 410. Accordingly, the door 300 can be continuously moved without being interfered with the first and second lift pieces 420 and 430.

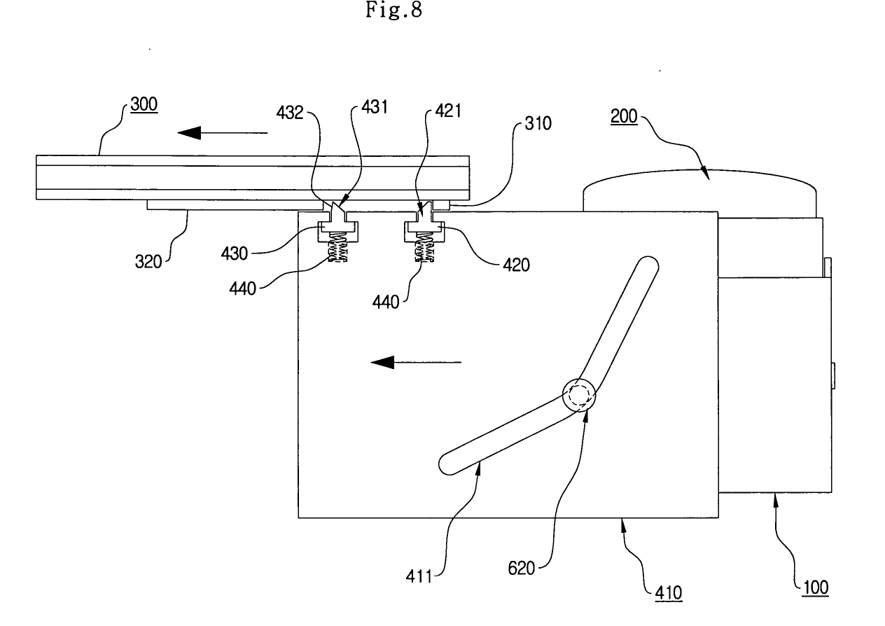

As shown in FIG. 8, when the door 300 is moved a certain distance in an opening direction as to be passed over the opening of the receiving space 11, the first protrusion 310 becomes to be engaged with the opposite surface of the slant surface 421 of the first lift piece 420. Then, if the door 300 is further moved in the opening direction, the first lift piece 420 is accordingly pushed by the first protrusion 310 so that the cam plate 410 is moved in association with the movement of the door 300. When the cam plate 410 is moved like this, the camera 200 is also interlinked and pivotally moved upward, finally being protruded outside the receiving space 11. Since the movement of the cam plate 410 starts at a point that the door 300 is moved over the opening of the receiving space 11, the camera 200 cannot be interfered with the door 300 even upon being protruded.

Meanwhile, when the door 300 starts to be moved again from a completely opened position toward a closing direction, the second protrusion 320 becomes to be in contact with the opposite surface of the slant surface 431 of the second lift piece 430 to push the second lift piece 430 toward the movement direction of the door 300. Thus, the cam plate 410 is moved to its initial position before the door 300 closes the opening of the receiving space 11, so that the camera 200 can be received in the case 100 in the receiving space 11 without being interfered with the door 300.

On the opposite surface of the slant surface 431 of the second lift piece 430, another more-slant surface 432 is formed to have an angle of inclination larger than that of the slant surface 431. When the door 300 is completely opened and then closed again, the second protrusion 320 of the door 300 will be in contact with the more-slant surface 432. In order to downward move the second lift piece 430 against a resilient force of the spring 440, larger force should be horizontally applied to the more-slant surface 432 relative to a force applied to the slant surface 431 (which larger force means a force larger than one required for moving the cam plate 410). Thus, when the slide door 300 is moved toward a closing direction so that the more-slant surface 432 is pushed by the second protrusion 320, the cam plate must be firstly moved. Then, when the cam plate 410 is completely moved to its initial position so that it cannot be furthermore moved, upon further movement of the door 300, a sufficiently large force must be applied to the door 300 so that a vertically downward component force of the force applied to the more-slant surface 432 exceeds a resilient force of the spring 440. Thus, the second lift piece 430 is moved downward, so that the second protrusion 320 of the door 300 can be moved across the second lift piece 430.

Hereinafter, an operation of the camera 200 being protruded from and received in the mobile communication terminal will be described in detail.

FIGS. 3 to 5 shows a state that the door 300 is in a closed position in which it completely closes the receiving space 11. In this state, the camera 200 is completely received in the body 10 of the terminal, i.e., the receiving space 11, and the opening of the receiving space 11 is blocked with the door 300, so that foreign substances cannot be intruded in the receiving space from exterior, thus preventing the contamination of a lens 201 of the camera 200 due to the foreign substances.

In this closed position, as shown in FIG. 3, the guide protrusion 210 of the camera 200 is positioned at utmost lower portion of the guide slot 110 of the camera case 100. Also, as shown in FIG. 4, the first shaft portion 620 of the connection shaft 600 is also positioned at utmost lower portion of the cam slot 411 of the cam plate 410. The first protrusion 310 of the door 300 is in a free state that it is not interfered with the first and second lift pieces 420 and 430, and the second protrusion 320 presses the first lift piece 420 downward.

When users move the door in an opening direction (arrow direction in FIG. 4) and open the door in order to shoot, the door 300 is naturally moved until the first protrusion 310 becomes to be in contact with the first lift piece 420. When the first protrusion 310 becomes to be in contact with the first lift piece 420, a rear portion of the door 300 is already in a position away from the opening of the receiving space 11.

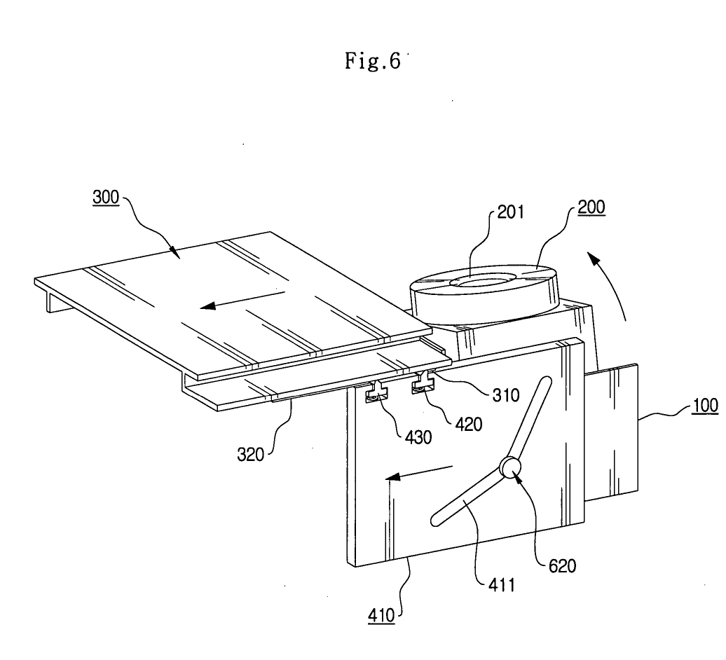

When the door 300 is continuously moved in the opening direction even after it passes over the opening of the receiving space 11, as shown in FIGS. 6 and 8, the first lift piece 420 is pushed by the first protrusion 310 of the door 300 so that the cam plate 410 becomes to be moved in the opening direction together with the door 300. With the movement of the cam plate 410, the first shaft portion 620 of the connection shaft 600 connected with the cam slot 411 will be moved upward along the cam slot 411.

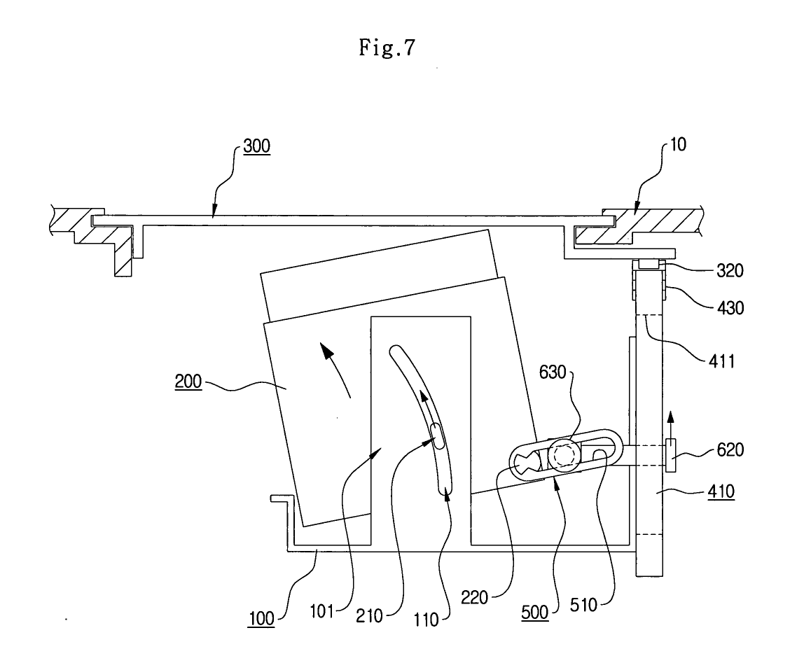

When the first shaft portion 620 of the connection shaft 600 is moved upward, as shown in FIG. 7, the connection loop 500 and therefore the fixing axis 220 of the camera 200 are moved upward accordingly. Herein, since the guide protrusion 210 of the camera 200 is coupled with the circular guide slot 110 of the case 100 as to be slidingly moved, when the fixing axis 220 is moved upward according to the upward movement of the connection loop 500, the camera 200 is also moved upward while being pivotally moved along the circular guide slot 110.

Since the second shaft portion 630 of the connection shaft 600 is rollingly and slidingly moved in the long hole 510 of the connection loop 500, a linear movement of the connection shaft 600 is smoothly converted into a pivotal movement of the camera 200.

Meanwhile, as shown in FIG. 8, the second protrusion 320 of the door 300 becomes to be moved across the second lift piece 430 in a state that the first protrusion 310 of the door 300 is in contact with the first lift piece 420.

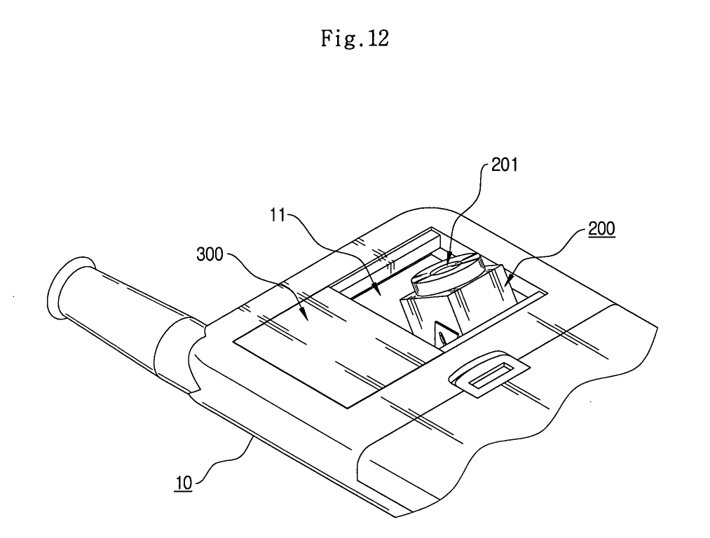

FIGS. 9 to 12 show a state that the door 300 is completely opened. As shown in FIGS. 9 to 12, if the door 300 is completely opened, the first shaft portion 620 of the connection shaft 600 is moved upward up to the upper portion of the cam slot 411 and accordingly, the camera 200 is completely popped out from the body 10 of the terminal, so that a shooting can be conducted.

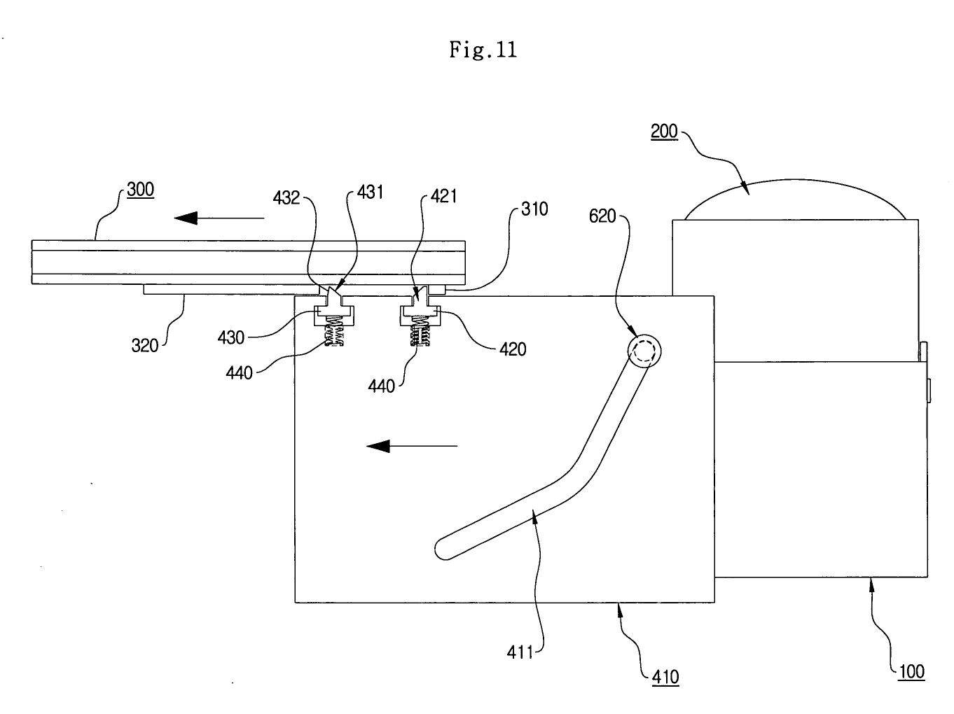

If the shooting is completely conducted in a state that the camera 200 is exposed outside, users move the door in a closed direction (an opposite arrow direction of FIG. 11) and close the door 300 in order to receive the camera 200 again in the body 10 of the terminal. Herein, the second protrusion 320 of the door 300 becomes to be in contact with the more-slant surface 432 of the second lift piece 430 directly, so that the cam plate 410 is moved in the closed direction with the door 300.

When the door 300 is continuously moved in the closed direction so that the leading end thereof approaches near the opening of the receiving space 11, the first shaft portion 620 of the connection shaft 600 is correspondingly moved down up to the lower portion of the cam slot 411 so that the camera 200 is also completely pivoted down to be received in the case 100 as shown in FIG. 3. In this state, the cam plate 410 becomes to be in contact with the sidewall of the terminal body 10 not to be moved furthermore so that a repulsive force is applied against a force pushing the door 300. Herein, if users push the door 300 in the closed direction with larger force, the second protrusion 320 of the door 300 can be moved across the more-slant surface 432 of the second lift piece 430.

The second protrusion 320 moved across the second lift piece 430 is continuously moved to contact the slant surface 421 of the first lift piece 420 and to be further moved across the first lift piece 420 in the closed direction, finally being completely returned to its closed position as shown in FIG. 4.

As described before, in a mobile communication terminal equipped with a camera according to the present invention, the camera is popped out from the terminal only when the door is opened by a simple mechanical structure without using a motor and the like, preventing the camera from being damaged due to external shocks and from being contaminated due to foreign substances.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A mobile communication terminal, comprising:
a body;
a camera installed in a receiving space formed in the body so as to be pivotally moved up and down;
a door installed on an outer surface of the body so as to be slidingly moved to open and close an opening of the receiving space; and
a cam plate installed in the body as to be slidingly moved in association with the movement of the door to pivotally move the camera.

2. The mobile communication terminal as claimed in claim 1, further comprising a camera case installed in the receiving space and in which the camera is safely received,
wherein the camera case has a sidewall with a circular guide slot formed thereto, and the camera has a sidewall with a guide protrusion formed thereon so as to be inserted into the guide slot, so that the camera is pivotally moved along a path of the guide slot, selectively being popped out from the body.

3. The mobile communication terminal as claimed in claim 1, wherein the cam plate includes a slant cam slot having a height corresponding to that of pivotal movement of the camera and a length corresponding to a moving distance of the door, and a connection shaft is further provided for converting a linear movement of the cam plate into a pivotal movement of the camera and which has one end connected with the cam slot as to be slidingly moved along the cam slot and the other end connected with the camera as to be pivotally moved.

4. The mobile communication terminal as claimed in claim 3, further comprising a fixing axis protruded from one side of the camera parallel to a movement direction of the cam plate, and a connection loop having one end rotatably fixed to the fixing axis and the other end extending toward the cam plate,
wherein the connection shaft includes a first shaft portion to be inserted into the cam slot of the cam plate, and a second shaft portion to be inserted into the connection loop.

5. The mobile communication terminal as claimed in claim 4, further comprising:
a pair of lift pieces installed spaced apart a certain distance to an upper portion of the cam plate as to be resiliently moved vertically;
a spring resiliently supporting the lift piece; and
a pair of protrusions formed spaced apart a certain distance on a lower surface of the door as to be selectively engaged with a side face of any one of lift pieces along a movement direction of the door so as to interlock the cam plate with the door.

6. The mobile communication terminal as claimed in claim 5, wherein the lift pieces include slant surfaces, respectively, facing each other, and any one of the lift pieces includes another more-slant surface opposite to the slant surface, the more-slant surface having an angle of inclination larger than that of the slant surface.
